(19) United States
(12) Patent Application Publication
(10) Pub. No.: US 2023/0275486 A1
(43) Pub. Date: Aug. 31, 2023

(54) END PLATE

(71) Applicant: Hilti Aktiengesellschaft, Schaan (DE)

(72) Inventors: Konrad ARTMANN, Schondorf (DE); Wolfgang LUDWIG, Zaisertshofen (DE); Wolfgang SCHREIBER, Buchloe (DE); Tobias SCHMID, Emmenhausen (DE)

(21) Appl. No.: 18/016,125

(22) PCT Filed: Jul. 13, 2021
(86) PCT No.: PCT/EP2021/069455

§ 371 Date: Jan. 13, 2023

(30) Foreign Application Priority Data
Jul. 23, 2020 (EP) 20187404.7

(51) Int. Cl. H02K 5/15; H02K 5/10

(52) U.S. Cl. CPC H02K 5/15; H02K 5/10

(57) ABSTRACT

An end plate for an electric motor, having a receiving device with an inner lateral surface for receiving and holding at least one bearing, wherein at least four symmetrically arranged, radially extending elevations are positioned on the inner lateral surface of the receiving device such that there is a clearance for receiving and holding at least one sealing element between two internal elevations on the inner lateral surface and two external elevations on the inner lateral surface.

The present invention relates to an end plate for an electric motor, having a receiving device with an inner lateral surface for receiving and holding at least one bearing.

### BACKGROUND

Electric motors, for example in the form of a drive for a power tool, usually have an end plate for receiving and holding a ball bearing. The ball bearing serves to mount one end of a rotor shaft. The rotor shaft projects out of the laminated core of the electric motor and transmits the torque generated in the electric motor to other components, for example a transmission.

### SUMMARY OF THE INVENTION

In order that the rotor shaft is mounted optimally with the aid of the (ball) bearing and possible damage to the bearing can be prevented, it is necessary, among other things, for conjoint rotation or rotation of an outer ring of the bearing relative to an inner ring of the bearing to be avoided.

Apparatuses known from the prior art for preventing conjoint rotation or rotation of a bearing outer ring relative to a bearing inner ring are usually insufficient and/or too complex.

It is an object of the present invention to provide an end plate for an electric motor, with which the abovementioned problem can be solved.

The present invention provides an end plate for an electric motor, having a receiving device with an inner lateral surface for receiving and holding at least one bearing.

According to the invention, at least four symmetrically arranged, radially extending elevations are positioned on the inner lateral surface of the receiving device such that there is a clearance for receiving and holding at least one sealing element between two internal elevations on the inner lateral surface and two external elevations on the inner lateral surface. As a result, conjoint rotation or rotation of an outer ring of the bearing relative to an inner ring of the bearing can be avoided in an effective manner. The sealing element serves as a braking element with which the bearing outer ring can be braked. As a result of the sealing element being positioned in the clearance between the elevations, the sealing element and consequently also the bearing are held in a predetermined orientation.

According to one advantageous embodiment of the present invention, it may be possible for the internal elevations to be positioned in an offset manner with respect to the external elevations, such that there is no straight passage between the elevations in an axial direction. This makes it possible to prevent the sealing element positioned between the elevations from being shifted locally on the inner lateral surface of the receiving device.

According to a further advantageous embodiment of the present invention, it may be possible that the clearance is configured in the form of a slot between the elevations.

According to a further advantageous embodiment of the present invention, it may be advantageous that between four and twelve elevations are positioned on the inner lateral surface of the receiving device. As a result, better positioning of the sealing element between the elevations can be achieved.

According to a further advantageous embodiment of the present invention, it may be possible that the at least one sealing element is configured in the form of an O-ring. The O-ring consists in this case of an elastic material.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to produce useful further combinations.

In the figures:

FIG. 1 invention;

shows a perspective view of an end plate according to the FIG. 2 shows a lateral sectional view through the end plate;

FIG. 3 shows a lateral sectional view of an upper portion of a bearing, and a sealing element;

FIG. 4 shows a lateral sectional view through an electric motor with the end plate without a bearing, sealing element and rotor shaft;

FIG. 5 shows a lateral sectional view through the electric motor with the end plate and the sealing element, without a bearing and rotor shaft;

FIG. 6 shows a lateral sectional view through the electric motor with the end plate, the sealing element and the bearing and without a rotor shaft; and

FIG. 7 shows a lateral sectional view through the electric motor with the end plate, the sealing element, the bearing and the rotor shaft.

### DETAILED DESCRIPTION

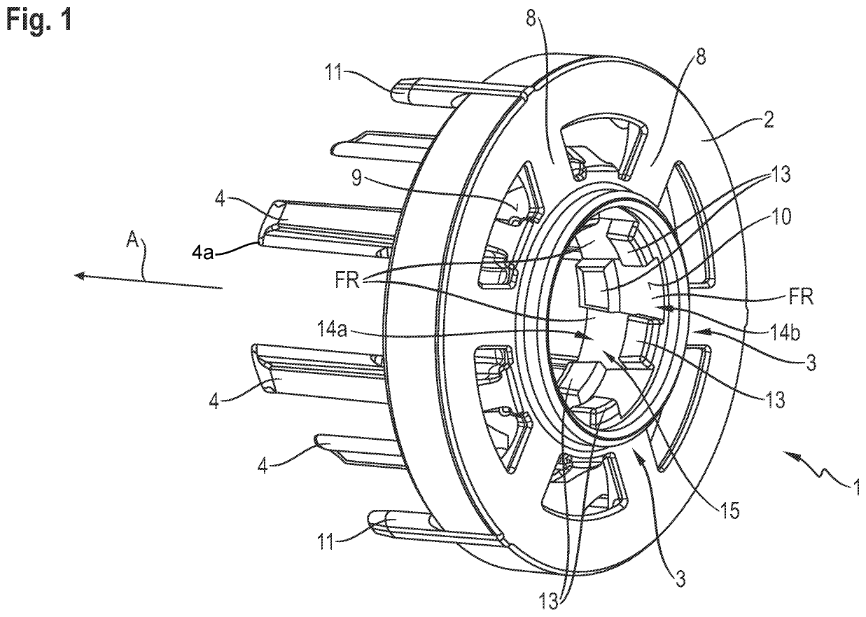

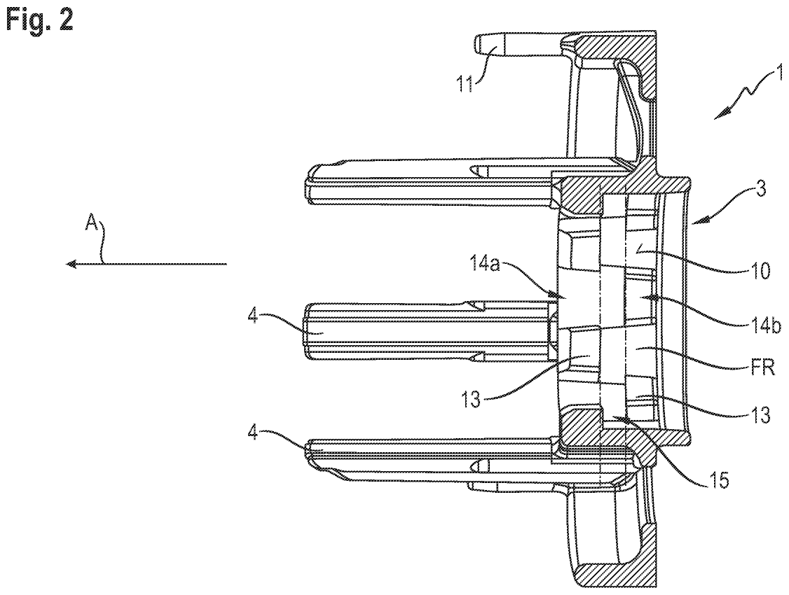

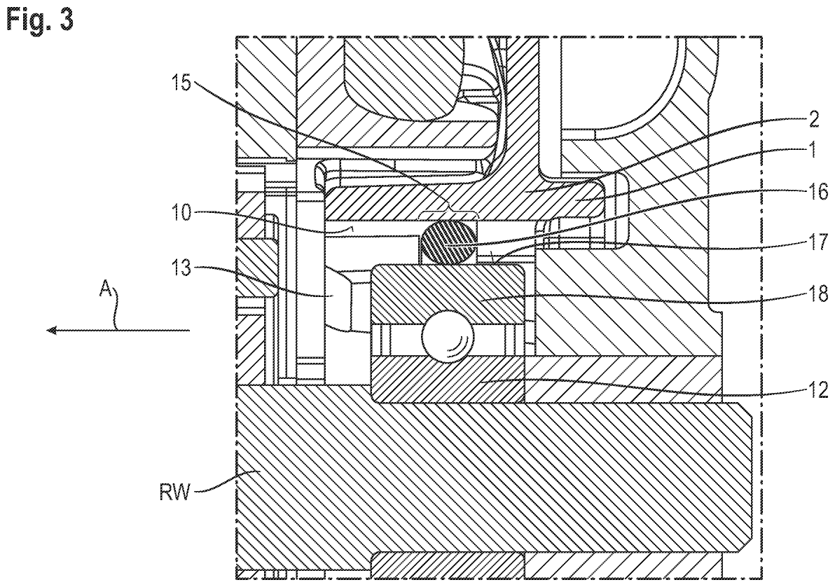

FIG. 1 shows an end plate 1 according to the invention. The end plate 1 has primarily an outer ring element 2, a receiving device 3 and a number of retaining bars 4.

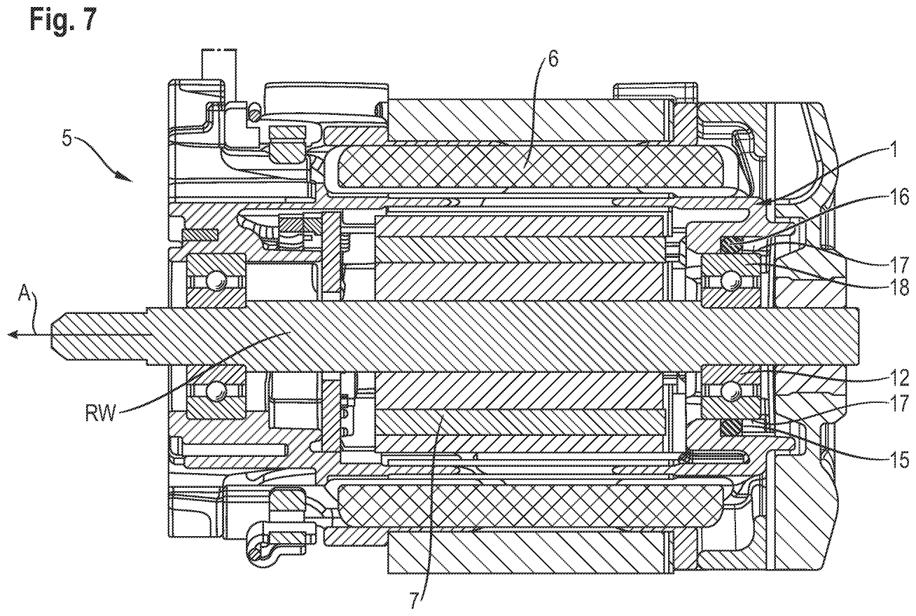

As indicated in the figures, the end plate 1 is provided to be attached to an electric motor 5 (see, e.g., FIG. 7). The electric motor 5 contains primarily a stator 6, a rotor 7 that rotates relative to the stator 6, and a rotor shaft RW connected to the rotor 7 for conjoint rotation.

The receiving device 3 is positioned centrally in the interior of the outer ring element 2. Six radially extending spoke elements 8 connect the outer ring element 2 to the receiving device 3 (see, e.g., FIG. 1).

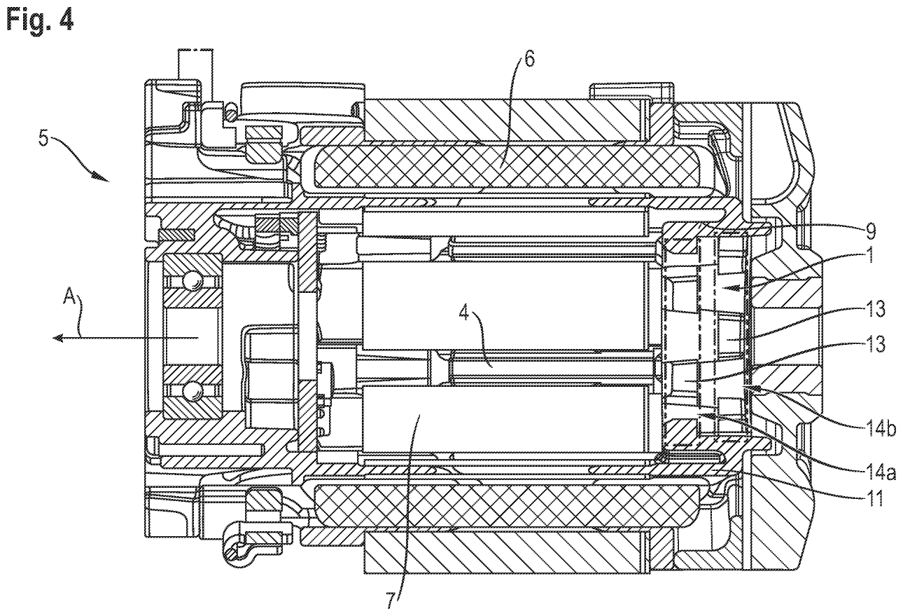

The receiving device 3 has an outer lateral surface 9 and an inner lateral surface 10. As indicated in FIG. 1, the retaining bars 4 extend in an axial direction A from the outer lateral surface 9 of the receiving device 3. The retaining bars 4 serve for positioning and fixing the end plate 1 on the stator 6 (cf. FIGS. 4 to 7). The free ends 4a of the retaining bars 4 (see, e.g., FIG. 1) are, to this end, pushed into the respective clearances between the coils of the stator 6.

As is likewise apparent from FIG. 1, the outer ring element 2 has three axially extending fixing bars 11. These fixing bars 11 serve additionally for fastening the end plate 1 to the stator 6.

The inner lateral surface 10 of the receiving device 3 serves for receiving and holding at least one bearing 12. In the present exemplary embodiment, the bearing 12 is configured as a ball bearing. Alternatively, the bearing 12 can also be configured in the form of a plain bearing or needle bearing.

As is indicated in particular in FIGS. 1 and 2, the receiving device 3 has symmetrically arranged, radially extending elevations 13 on its inner lateral surface 10. As is apparent from the figures, each elevation 13 is configured in a slightly conical manner.

In the present exemplary embodiment, the elevations 13 are positioned in a first and a second annular arrangement 14a, 14b. The first annular arrangement 14a of elevations 13 is positioned after the second annular arrangement 14b of elevations 13 in the arrow direction A. The elevations 13 of the first and second annular arrangements 14a, 14b are arranged in an offset manner with respect to one another such that no elevation 13 of the first or second annular arrangements 14a, 14b is arranged one after another in the arrow direction A. In other words: Each elevation 13 of the second annular arrangement 14b is aligned in an axial arrow direction A with a clearance FR between two elevations 13 of the first annular arrangement 14a. The elevations 13 of the first and second annular arrangements 14a, 14b are thus not positioned one after another in the axial arrow direction A, but in an offset manner with respect to one another. Furthermore, the elevations 13 of the first and second annular arrangements 14a, 14b are spaced apart from one another in the axial arrow direction A such that there is an annular clearance 15 between the two annular arrangements 14a, 14b of the elevations 13. The annular clearance 15 can also be referred to as a slot or ring slot. FIG. 2 illustrates the annular clearance 15 between the two dashed lines.

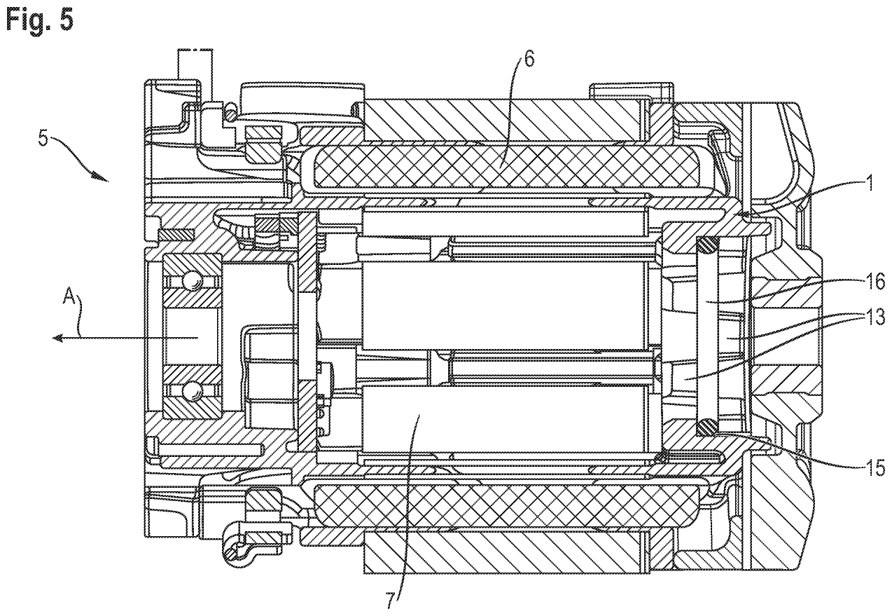

A sealing element 16 has been inserted into the annular clearance 15 (cf. FIG. 5). The width of the annular clearance 15 in the axial arrow direction A corresponds approximately to the width of the cross-sectional area of the sealing element 16.

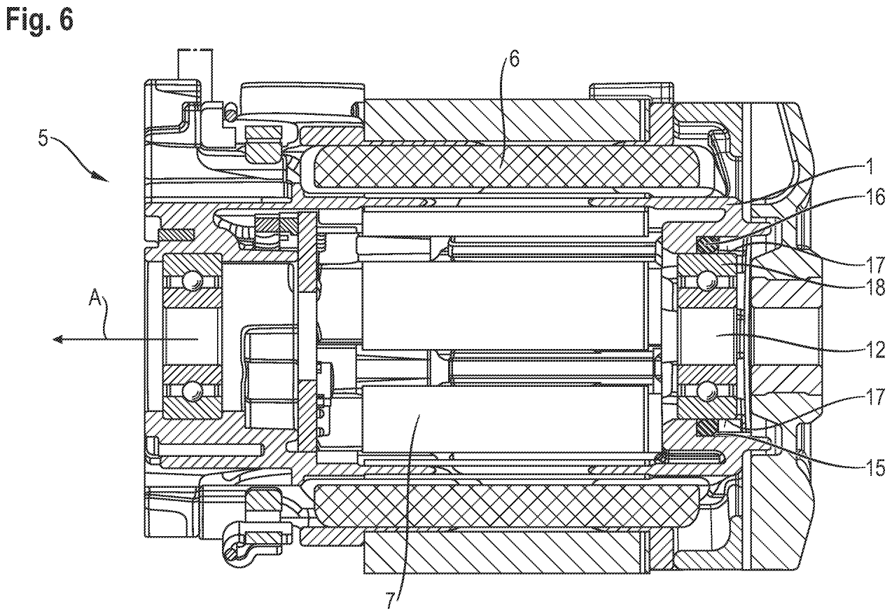

As is apparent from FIG. 6, the bearing 12 is positioned in the receiving device 3. The sealing element 16 is located between the inner lateral surface 10 of the receiving device 3 and the outer lateral surface 17 of the bearing 12. The dimensions of the inside diameter of the receiving device 3, of the outside diameter of the bearing 12, and the width of the cross-sectional area of the sealing element 16 are chosen such that the outer lateral surface 17 of the bearing 12 and the inner lateral surface 10 of the receiving device 3 press against the sealing element 16. The sealing element 16 is somewhat squeezed and deformed such that the sealing element 16 is pressed into the clearances FR between the individual elevations 13. As a result of the squeezing and the resultant deformation of the sealing element 16, the bearing 12 is firmly positioned in the receiving device 3. The sealing element 16 serves as a brake and prevents the bearing 12 and in particular a bearing outer ring 18 from turning.

### LIST OF REFERENCE SIGNS

1 End plate
2 Outer ring element
3 Receiving device
4 Retaining bars
5 Electric motor
6 Stator
7 Rotor
8 Spoke element
9 Outer lateral surface of the receiving device
10 Inner lateral surface of the receiving device
11 Fixing bar
12 Bearing
13 Elevation
14a First annular arrangements of elevations
14b Second annular arrangements of elevations
15 Annular clearance
16 Sealing element
17 Outer lateral surface of the bearing
18 Bearing outer ring
FR Clearance
RW Rotor shaft

1-4. (canceled)

5. An end plate for an electric motor, the end plate comprising:
a receiver with an inner lateral surface for receiving and holding at least one bearing; and
at least four symmetrically arranged, radially extending elevations positioned on the inner lateral surface to define a clearance for receiving and holding at least one seal between two internal elevations of the elevations on the inner lateral surface and two external elevations of the elevations on the inner lateral surface.

6. The end plate as recited in claim 5 wherein the clearance is configured in the form of a slot between the internal and external elevations.

7. The end plate as recited in claim 5 wherein the at least four elevations numbers between four and twelve elevations positioned on the inner lateral surface of the receiving device.

8. The end plate as recited in claim 5 wherein the at least one seal is configured in the form of an O-ring.
